(19) United States
(12) Patent Application Publication
(10) Pub. No.: US 2007/0248935 A1
(43) Pub. Date: Oct. 25, 2007

(54) DENTAL DRILL

(75) Inventors: KARL-HEINZ DANGER, DETMOLD (DE); MICHAEL KRUMSIEK, LEMGO (DE)

Correspondence Address: SHERIDAN ROSS PC, 1560 BROADWAY, SUITE 1200, DENVER, CO, 80202, US

(73) Assignee: GEBR. BRASSELER GMBH & CO. KG, Lemgo (DE)

(21) Appl. No.: 11/738,285

(22) Filed: Apr. 20, 2007

(30) Foreign Application Priority Data
Apr. 24, 2006 (DE) 10 2006 018 933.7

(51) Int. Cl. A61C 3/02

(52) U.S. Cl. 433/165

(57) ABSTRACT

The invention refers to a dental drill having a head 1 provided with cutting edges, the head having an at least rounded basic shape, wherein two of the cutting edges 2, 3 merge into a transitional cutting edge 4 at the front side, characterized in that the dental drill is made of a ceramic material and that the cutting edge chipping is between 2.5 and 7 μm and the cutting edge base 5 has a radius between 0.03 and 0.12 mm.

The invention refers to a dental drill having the features according to the preamble portion of claim 1.

In detail, the invention relates to a dental drill having a head provided with cutting edges, wherein the head has an at least rounded basic shape. Same may be spherical or pear-shaped, as it is known from the state of the art.

It is an object underlying the invention to provide a dental drill of the aforementioned kind, which enables an enhanced treatment of a tooth and an enhanced removal of diseased dentin during the cavity treatment.

According to the invention, the object is solved by the feature combination of the main claim, the sub-claims show further advantageous embodiments of the invention.

According to the invention, it is thus provided that the dental drill is made of a ceramic material. The dimensioning and physical form is therein carried out such that the chipping of the cutting edges (cutting edge chipping) is between 2.5 and 7 μm and that the cutting edge base has a radius between 0.03 and 0.12 mm. Cutting edge chipping in the sense of the invention means the depth of the notch resulting during the manufacturing of the dental drill and the generation of the cutting edge.

According to the invention, it turned out that the dental drill is particularly preferably suited for removing diseased dentin from cavities during a cavity treatment, wherein diseased dentin is removed, however, sane dentin is preserved. This is contrary to the metallic dental drills which, due to the material selected and the geometry of the cutting edges, also remove sane dentin.

With the embodiment of the cutting edges, it may be achieved that the dental drills cut into soft/carious material and only scrape over the surface in case of solid, sane tooth substance and remove nearly no more material. There results a certain tactile feeling by which the user receives a feedback. Same may be achieved by different tooth profiles as well as different tooth divisions and tooth depths such that the effective angles within a dental drill possibly differ.

The inventive dental drill is therefore particularly suited to excavate caries.

The shape of the head is preferably round or pear-shaped, the head has at its front side a transitional cutting edge or cross cutting edge which is formed by a co-operation of two or more cutting edges. Therewith, the cutting performance as well as the guiding of the dental drill are enhanced.

Preferably, the inventive dental drill is made of zirconium oxide or zirconium oxide with additives.

According to the invention, it is possible to use different numbers of cutting edges, i.e. four, six, eight or ten cutting edges, depending on the dimensioning and physical form of the head of the inventive dental drill.

Due to the cutting edge chipping between 2.5 and 7 μm as well as the radius of the cutting edge base between 0.03 and 0.12 mm, as provided according to the invention, there results on the one hand a desired cutting performance, and on the other hand, the strength and thus the service life of the ceramic dental drill are considerably increased.

It is particularly advantageous if the chip angle is between 0° and −25°. In this context, it is preferable if the wedge angle is between 40° and 60°.

Due to the rounding of the cutting edge base with the aforementioned radius as well as the inventive rounding of the transitional areas suitable to ceramic, there results a high load capacity of the cutting edges. In addition, the cut chips may be removed easily and cannot wedge in the chip base. This results in an enhanced excavating performance of the inventive dental drill. The inventive embodiment therefore leads to a construction suitable to ceramic including a rounding of edges and transitional areas. The cutting edges themselves, however, are sharply ground and have a cutting tip in the cross-section.

In the following, the invention is described on the basis of embodiments in connection with the drawings, in which:

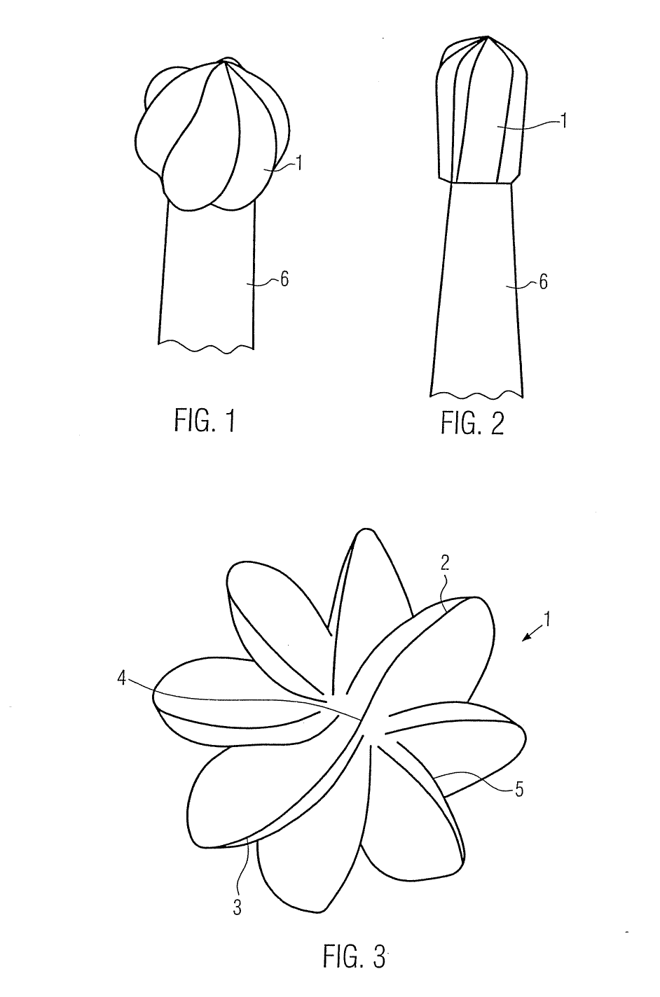

FIG. 1 shows a schematic side view of an inventive dental drill having a substantially spherical head,

FIG. 2 shows a side view, analogue to FIG. 1, with a substantially pear-shaped head,

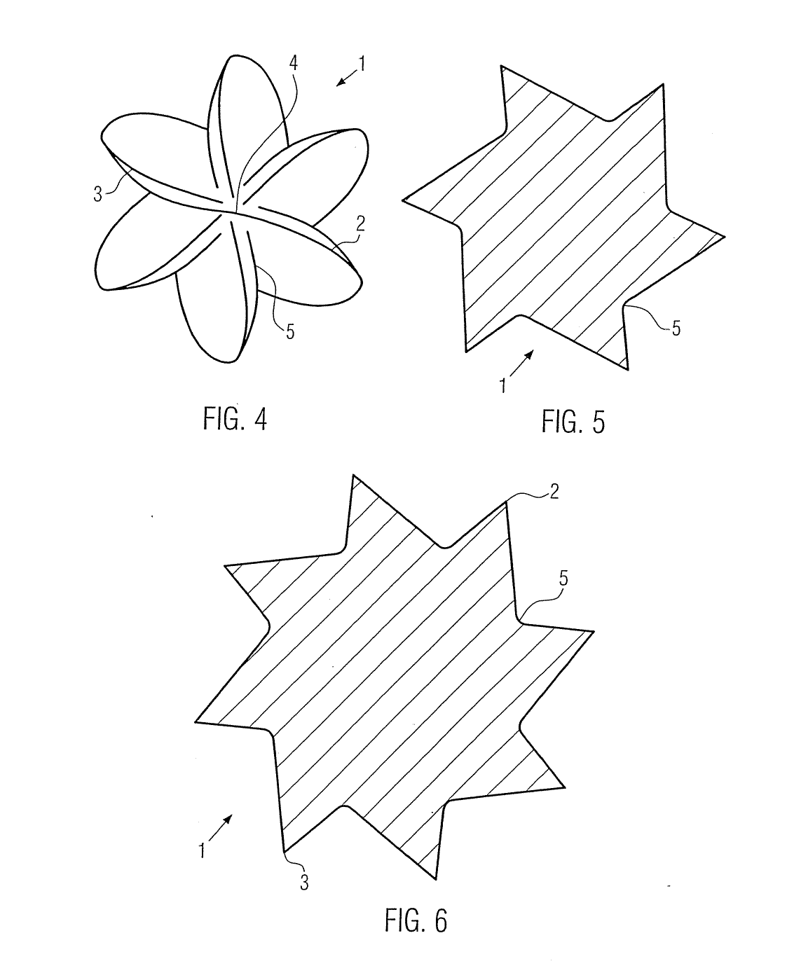

FIGS. 3 and 4 show front side plan views onto two different embodiments,

FIGS. 5 and 6 show sectional views in a radial plane of the embodiments shown in FIGS. 3 and 4,

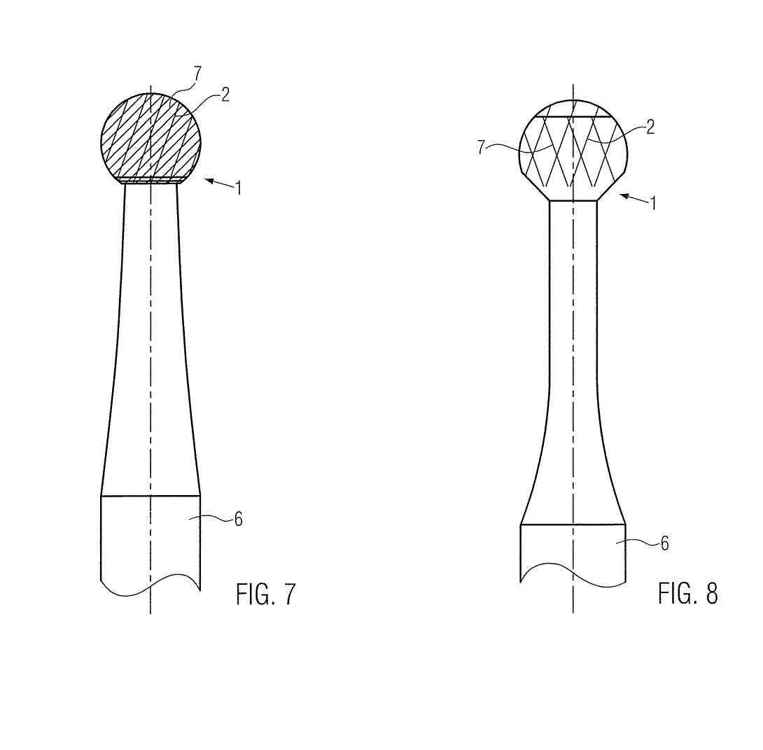

FIGS. 7 and 8 show schematic side views of further embodiments, wherein the cutting edges are provides with at least one cross-cut,

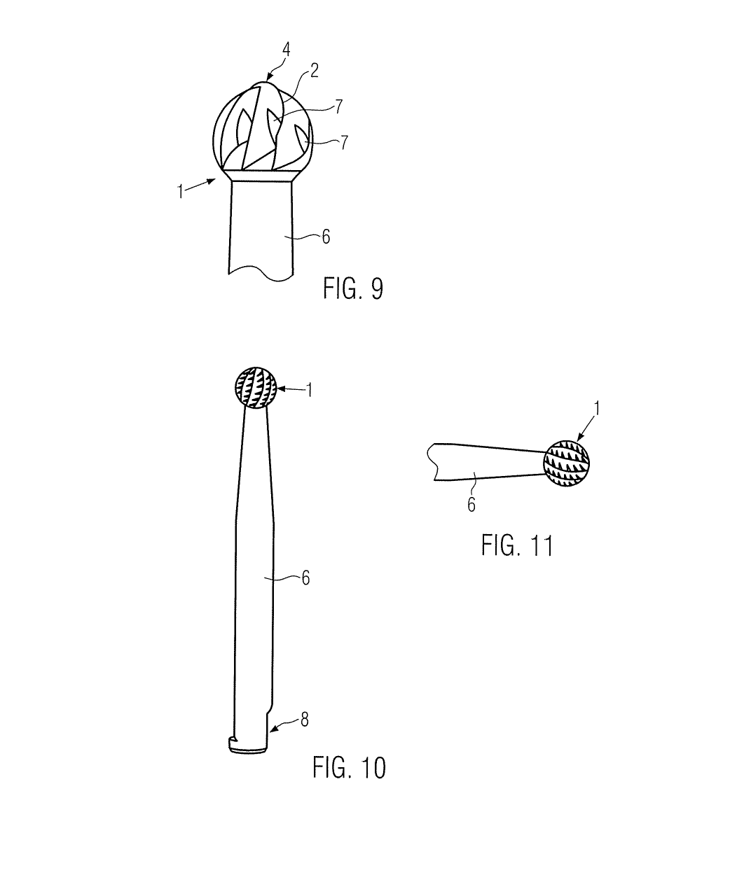

FIG. 9 shows a perspective side view of an embodiment, analogue to FIG. 1, wherein each cutting edge comprises a cross-cut, and

FIGS. 10 and 11 show detailed views of an embodiment in which each cutting edge comprises a plurality of cross-cuts.

As results from FIGS. 1 and 2, the inventive dental drill comprises a head 1 attached to a shaft 6 and integrally connected therewith. The number of cutting edges as well as the shape of the head depends on the respective purpose of use and the respective physical form. FIG. 1 shows a substantially spherical head, whereas the head according to FIG. 2 is substantially pear-shaped.

FIGS. 3 and 4 respectively show front views of two different embodiments. The embodiment of FIG. 3 comprises in total eight cutting edges. Thereof, two cutting edges 2, 3 are formed such that they merge into each other at the front sides and form a transitional cutting edge or cross cutting edge 4.

In the embodiment according to FIG. 4, six cutting edges are provided in total, wherein again the cutting edges designated with reference numerals 2 and 3 merge into a transitional cutting edge or cross cutting edge 4.

FIGS. 5 and 6 respectively show sectional views in the radial plane (with respect to the rotary axis of the dental drill). FIG. 5 corresponds to the embodiment of FIG. 4, whereas FIG. 6 corresponds to the embodiment of FIG. 3. According to the invention, it is provided that the cutting edge base 5 has a radius between 0.03 and 0.12 mm. Therewith, a rounding of the transitional areas is given, which reduces notch tensions and prevents the deposition of chips during operation.

FIG. 7 to 11 respectively show embodiments having a spherical head 1, wherein at least one cross-cut is provided in each of the cutting edges 2, 3. FIG. 9, in particular, shows an embodiment in which a cross-cut 7 having the shape of a depression-like rounded recess is provided at each of the cutting edges 2, 3.

FIGS. 10 and 11 show an embodiment in which each cutting edge is provided with a plurality of cross-cuts. Same may be arranged to be helically circumferential around the longitudinal axis. The cross-cuts 7 may be arranged in a single row (as shown in FIG. 9) or a multi row (as shown in FIGS. 10 and 11).

FIG. 10 further shows that a chucking portion 8 for the dental drill is formed at the lower end of the shaft 6, which comprises an oblateness as well as a circumferential fixing groove, as it is pre-known from the state of the art.

List of Reference Numerals

1 head
2 cutting edge
3 cutting edge
4 transitional cutting edge/cross cutting edge
5 cutting edge base
6 shaft
7 cross-cut
8 chucking portion

1. A dental drill comprising: a head having a plurality of cutting edges, the head further having an at least rounded basic shape, wherein two of the cutting edges merge into a transitional cutting edge at a front side, and wherein the dental drill is made of a ceramic material and a cutting edge chipping is between about 2.5 and 7 μm and a cutting edge base has a radius between about 0.03 and 0.12 mm.

2. The dental drill of claim 1, wherein the cutting edges are formed such that the dental drill cuts into soft material and does not remove tooth substance if same is solid.

3. The dental drill of claim 1 wherein:
the chip angle is between about 0° and −25°.

4. The dental drill of claim 1 wherein:
the wedge angle is between about 40° and 60°.

5. The dental drill of claim 1 wherein:
the cutting edges include four cutting edges.

6. The dental drill of claim 1 wherein:
the cutting edges include six cutting edges.

7. The dental drill of claim 1 wherein:
the cutting edges include eight cutting edges.

8. The dental drill of claim 1 wherein:
the cutting edges include ten cutting edges.

9. The dental drill of claim 1 wherein:
the head has a round contour.

10. The dental drill of claim 1 wherein:
the head has a pear-shaped contour.

11. The dental drill of claim 1 wherein:
the cutting edges are respectively provided with at least one cross-cut.

12. The dental drill of claim 11, wherein:
the cross-cut is formed in the shape of a rounded groove being processed in the cutting edge position.
